(19) United States
(12) Patent Application Publication
(10) Pub. No.: US 2026/0101426 A1
(43) Pub. Date: Apr. 9, 2026

(54) X-RAY ELECTRON EMISSION CONTROL DEVICE

(71) Applicant: LG ELECTRONICS INC., Seoul (KR)

(72) Inventors: Youngsik KIM, Seoul (KR); Taehyung KIM, Seoul (KR); Hyojin NAM, Seoul (KR); Jeongsoon YIM, Seoul (KR); Byungkee LEE, Seoul (KR); Jinah KIM, Seoul (KR); Mikiko ITO, Seoul (KR)

(73) Assignee: LG ELECTRONICS INC., Seoul (KR)

(21) Appl. No.: 19/115,196

(22) PCT Filed: Sep. 27, 2022
(86) PCT No.: PCT/KR2022/014447

§ 371 Date: Mar. 25, 2025

(51) Int. Cl. H05G 1/26; H05G 1/30

(52) U.S. Cl. CPC H05G 1/265; H05G 1/30

(57) ABSTRACT

The present invention relates to an X-ray electron emission control device which senses anode current and controls the anode current at a constant level, the device comprising: an electron emission unit which emits electrons; an anode which collects the electrons; a gate voltage source connected to a gate of the electron emission unit; a cathode current source connected to a cathode of the electron emission unit; a current sensing unit which is connected to the cathode current source and senses the anode current; and a current control unit which generates a current control signal on the basis of the sensed anode current and outputs same to the cathode current source. One side of the gate voltage source may be connected to the gate of the electron emission unit, and the other side may be connected to a branch point of a line connecting the cathode current source and the current sensing unit.

### TECHNICAL FIELD

The present disclosure relates to an X-ray electron emission control device that detects an anode current and controls the anode current to a constant level.

### BACKGROUND ART

In general, the types of electron emission devices applied to X-ray tubes include the field emitter method that uses tunneling current and the heater emitter method that uses thermionic emission.

In particular, the field emitter method that has recently attracted attention because it is digitally driven includes devices that use carbon nanotubes, field emission tips using MEMS technology, and Metal-Insulator-Metal (MIM) and Metal-Insulator-Semiconductor (MIS) elements using semiconductor technology, or the like.

The electron emission device is composed of a cathode terminal equipped with an emitter that emits electrons and a gate terminal that adjusts the emitted electron amount, and the cathode terminal and the gate terminal are packaged in a vacuum together with an anode terminal that collects the emitted electrons to form the electron emission device.

Electron-emitting devices may have different characteristics due to slight differences in the manufacturing process, and when a plurality of electron emission devices are used, an additional device is required to automatically adjust the current according to the characteristics of each.

As a method for obtaining a constant emission current, there is a method of controlling the anode current by detecting only the cathode current or detecting both the cathode current and the gate current for precise control.

However, the method of adjusting the anode current by detecting only the cathode current has the problem that precise control is difficult, and the method of controlling the anode current by detecting the cathode current and the gate current has the problem that the system configuration is complicated and mutual compensation is difficult due to the process of detecting and calculating the two currents, which entails additional costs.

Therefore, in the future, there is a demand for the development of an X-ray electron emission control device that can precisely control the anode current while enabling easy, simple, and inexpensive circuit implementation.

### DISCLOSURE

### Technical Problem

An object of the present disclosure is to solve the above-described problems and other problems.

An object of the present disclosure is to provide an X-ray electron emission control device capable of precisely controlling the anode current while enabling easy, simple, and inexpensive circuit implementation by connecting a current detection part to a cathode current source and connecting a gate voltage source to a branch point of a line connecting between the cathode current source and the current detection part, thereby detecting the anode current in a low voltage range without direct connection to the anode terminal.

### Technical Solution

An X-ray electron emission control device according to an embodiment of the present disclosure includes an electron emission part emitting electrons; an anode collecting the electrons; a gate voltage source connected to a gate of the electron emission part; a cathode current source connected to a cathode of the electron emission part; a current detection part connected to the cathode current source and detecting an anode current; and, a current control part generating a current control signal based on the detected anode current and outputting the current control signal to the cathode current source, in which the gate voltage source may have a side connected to the gate of the electron emission part and the other side connected to a branch point of a line connecting between the cathode current source and the current detection part.

An X-ray electron emission control device according to another embodiment of the present disclosure includes a plurality of electron emission parts including gates and cathodes; a plurality of anodes respectively arranged corresponding to the plurality of electron emission parts; a plurality of cathode current sources respectively connected to the cathodes corresponding to the plurality of electron emission parts; a gate voltage source connected to a gate of one specific electron emission part among the plurality of electron emission parts; a current detection part connected to the plurality of cathode current sources to detect an anode current; and, a current control part generating a current control signal based on the detected anode current and outputting the signal to the plurality of cathode current sources, in which the gate voltage source may have a side connected to the gate of the specific electron emission part and the other side connected to a branch point of a line connecting between the plurality of cathode current sources and the current detection part.

### Advantageous Effect

According to one embodiment of the present disclosure, an X-ray electron emission control device can precisely control the anode current while enabling easy, simple, and inexpensive circuit implementation by connecting a current detection part to a cathode current source and connecting a gate voltage source to a branch point of a line connecting between the cathode current source and the current detection part, thereby detecting the anode current in a low voltage range without direct connection to the anode terminal.

In addition, since the present disclosure detects the anode current through a single current detection device, the overall device configuration is simple, and since compensation is performed only for the anode current, the current can be precisely controlled.

In addition, since the present disclosure detects the anode current between the cathode terminal and the ground terminal of the device, it can be configured as a device having a voltage range corresponding to several V to several tens of V, and the stability of the entire device is high, and a high-precision current detection device can be easily implemented while also being able to be implemented at a low cost.

### DESCRIPTION OF DRAWINGS

FIG. 1 is a view for explaining an X-ray electron emission control device according to one embodiment of the present disclosure.

FIG. 2 is a view for explaining a current control part of an X-ray electron emission control device according to an embodiment of the present disclosure.

FIG. 3 is a view for explaining a current control part of an X-ray electron emission control device according to another embodiment of the present disclosure.

FIG. 4 is a view for explaining an X-ray electron emission control device according to another embodiment of the present disclosure.

FIG. 5 is a view for explaining an X-ray electron emission control device for simulation according to one embodiment of the present disclosure.

FIGS. 6 and 7 are graphs illustrating the results of simulating the X-ray electron emission control device of FIG. 5.

### BEST MODE

Hereinafter, embodiments disclosed in the present specification will be described in detail with reference to the attached drawings, and regardless of the drawing symbols, identical or similar components will be given the same reference numerals and redundant descriptions thereof will be omitted. The suffixes “module” and “part” for components used in the description below are assigned or mixed in consideration of easiness in writing the specification and do not have distinctive meanings or roles by themselves. In addition, when describing embodiments disclosed in this specification, if it is determined that a specific description of a related known technology may obscure the gist of the embodiments disclosed in this specification, the detailed description thereof will be omitted. In addition, the attached drawings are only intended to facilitate easy understanding of the embodiments disclosed in this specification, and the technical ideas disclosed in this specification are not limited by the attached drawings, and should be understood to include all modifications, equivalents, and substitutes included in the technical scope of the present disclosure.

Terms including ordinal numbers, such as first, second, or the like, may be used to describe various components, but the components are not limited by the terms. The terms are used only to distinguish one component from another.

When it is said that a component is “connected” or “accessed” to another component, it should be understood that it may be directly connected or accessed to that other component, but that there may be other components in between. On the other hand, when it is said that a component is “directly connected” or “directly accessed” to another component, it should be understood that there are no other components in between.

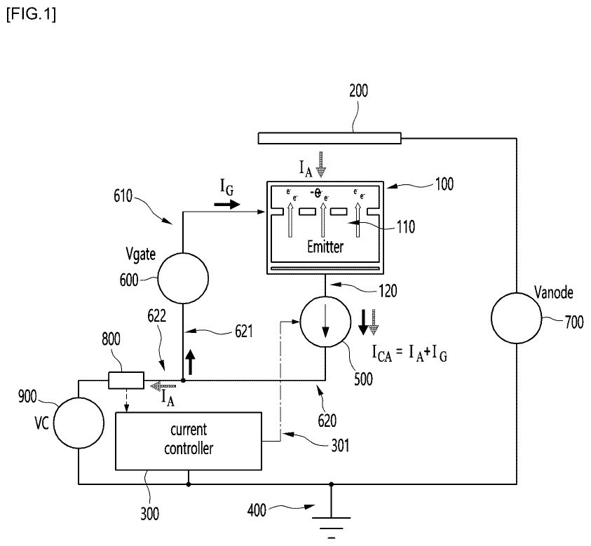

FIG. 1 is a view for explaining an X-ray electron emission control device according to one embodiment of the present disclosure.

As illustrated in FIG. 1, the X-ray electron emission control device of the present disclosure may include an electron emission part 100 that emits electrons, an anode 200 that collects electrons, a gate voltage source 600 connected to a gate 110 of the electron emission part 100, a cathode current source 500 connected to a cathode 120 of the electron emission part 100, a current detection part 800 connected to the cathode current source 500 to detect anode current, and a current control part 300 that generates a current control signal based on the detected anode current and outputs the generated current control signal to the cathode current source 500.

Here, the anode 200 and electron emission part 100 can be vacuum packaged to facilitate electron emission and collection.

Next, the gate voltage source 600 may have one side connected to the gate 110 of the electron emission part 100 and the other side connected to the branch point of the line 620 connecting the cathode current source 500 and the current detection part 800.

In addition, the cathode current source 500 can output the cathode current, which is the combination of the gate current and the anode current, to the branch point of the line 620 connecting the cathode current source 500 and the current detection part 800.

At this time, the gate voltage source 600 may be connected to a first branch line 621 branched from a branch point of line 620, and the current detection part 800 may be connected to a second branch line 622 branched from a branch point of line 620.

Accordingly, the gate voltage source 600 can receive the gate current branched through the first branch line 621 among the cathode current output from the cathode current source 500, and the current detection part 800 can receive the anode current branched through the second branch line 622 among the cathode current output from the cathode current source 500.

Here, the anode current branched through the second branch line 622 can have a current value calculated by a formula consisting of I_{A}=I_{CA}−I_{G} (where I_{A} is the anode current, I_{CA} is the cathode current, and I_{G} is the gate current).

In addition, the anode current branched through the second branch line 622 can increase in proportion to its increase rate when the gate current increases, and can decrease in proportion to its decrease rate when the gate current decreases.

Here, the anode current branched through the second branch line 622 can have a current value calculated by a formula consisting of I_{A}=(TR/(1−TR))I_{G} (where I_{A} is the anode current, TR is the transfer rate, and I_{G} is the gate current).

Next, the gate voltage source 600 may include a gate negative terminal connected to the first branch line 621 and a gate positive terminal connected to the gate line 610 of the electron emission part 100.

Here, the gate current amount supplied to the gate 110 of the electron emission part 100 through the gate line 610 connected to the gate positive terminal may be equal to the gate current amount input through the first branch line 621 connected to the gate negative terminal.

At this time, the gate voltage source 600 can increase the gate current in proportion to the increase in the cathode current of the cathode current source 500, and can decrease the gate current in proportion to the decrease in the cathode current of the cathode current source 500.

Next, the cathode current source 500 can adjust the cathode current in response to a current control signal input from the current control part 300.

Here, the cathode current source 500 can adjust the cathode current in response to the current control signal so that the gate voltage of the electron emission part 100 is fixed and the cathode terminal voltage of the electron emission part 100 is adjusted.

At this time, the cathode current source 500 can increase the cathode current in response to the current control signal to lower the cathode terminal voltage of the electron emission part 100, or can decrease the cathode current in response to the current control signal to increase the cathode terminal voltage of the electron emission part 100.

In addition, the current detection part 800 can receive the anode current from the branch point of the line 620 connecting the cathode current source 500 and the current detection part 800 and output a voltage proportional thereto to the current control part 300.

Here, the voltage output from the current detection part 800 can have a voltage value calculated by a formula consisting of V_{S}=Z_{S}I_{A} (where V_{S} is the output voltage of the current detection part, Z_{S} is the proportional constant of the current detection part, and I_{A} is the anode current).

For example, the current detection part 800 may include passive elements including a capacitor and an inductor, a hall sensor, and a current transformer, but this is only an example and is not limited thereto.

In addition, the X-ray electron emission control device of the present disclosure may further include a voltage source VC 900 having one side connected to a current detection part 800 and the other side connected to a ground part 400.

Here, the voltage source VC 900 can supply a constant voltage to the line 620, 621, 622 connecting the cathode current source 500 and the current detection part 800 via the current detection part 800.

Next, the current control part 300 may include an anode current detection amplification part that amplifies the output voltage of the current detection part 800, an error amplification part that compares the output voltage of the anode current detection amplification part with a reference voltage of a reference voltage source and amplifies an error value, and a frequency compensation part that generates a current control signal based on the output voltage of the error amplification part.

Here, the anode current detection amplification part has its input side connected to the current detection part 800, its output side connected to the reference voltage source connected to the ground part 400 and its output side connected to the error amplification part, and when the output voltage of the current detection part 800 is input, the anode current detection amplification part can output a voltage proportional to the input based on the grounding terminal.

In addition, the error amplification part includes a first input terminal connected to the anode current detection amplification part, a second input terminal connected to a reference voltage source, and an output terminal connected to a cathode current source, and the frequency compensation part may have one side connected to a connection line between the first input terminal of the error amplification part and the anode current sensing amplification part, and the other side connected to a connection line between the output terminal of the error amplification part and the cathode current source.

Additionally, the error amplification part and frequency compensation part can generate a current control signal that controls the output voltage of the current detection part 800 to be equal to the reference voltage.

In addition, the current control part 300 can generate a current control signal in which the anode current is adjusted through a formula consisting of I_{A}=V_{ref}/αZ_{S}, V_{ref}=αV_{S}, V_{S}=Z_{S}I_{A} (where V_{S} is the output voltage of the current detection part, Z_{S} is the proportional constant of the current detection part, I_{A} is the anode current, V_{ref} is the reference voltage, and αV_{S} is the output voltage of the current detection part).

As another embodiment, the current control part 300 may include a first analog-to-digital conversion part that converts the output voltage of the current detection part 800 into a first digital signal, a second analog-to-digital conversion part that converts the reference voltage of the reference voltage source into a second digital signal, a control part that performs computational processing on the first digital signal and the second digital signal, and an output part that generates and outputs a current control signal based on a processing result performed by the control part.

Here, the current control part 300 can output the current control signal as an analog signal or as a digital signal including either a Pulse Width Modulation (PWM) signal and a Pulse Frequency Modulation (PFM) signal.

In addition, the control part can perform computational processing based on a control algorithm including a Proportional Integral Derivative (PID) method, but this is only an example and is not limited thereto.

In addition, the X-ray electron emission control device of the present disclosure may further include an anode voltage source 700 having one side connected to the anode 200 and the other side connected to the ground part 400.

Next, the electron emission part 100 is composed of a gate 110 and a cathode 120 having an electron emission emitter, and a cathode current source 500 for adjusting cathode current is connected to a first branch line 621 having one side connected to the cathode 120 and the other side connected to the gate negative terminal of a gate voltage source 600.

Here, the current flowing in the line 620 connected to the cathode current source 500 can be branched into a first branch line 621 connected to the gate negative terminal of the gate voltage source 600 and a second branch line 622 connected to the current detection part 800.

The gate voltage source 600 is connected between the Vgate+ line, which is a gate line 610 connected to the gate 110 of the electron emission part 100, and the Vgate − line, which is a first branch line 621, and can generate a voltage difference between the Vgate+ line, which is a gate line 610, and the Vgate− line, which is a first branch line 621.

In addition, the gate voltage source 600 is separated from the ground part 400, and this type of voltage source can be configured as an isolated power converter.

An isolated power converter can fix one of the two output terminals (here, the gate positive terminal Vgate+ and the gate negative terminal Vgate−) to any power source.

Next, the voltage source VC 900 is a voltage source for fixing the gate negative terminal Vgate− to an appropriate voltage, and the voltage source VC 900 can apply a constant voltage to the first branch line 621, the second branch line 622, and the connection line 620 of the cathode current source 500 connected to the gate negative terminal Vgate− via the current detection part 800.

Thus, the operation of the present disclosure is as follows.

In the electron emission part 100, when the gate current I_{G} and the anode current I_{A} due to the emitted electrons flow, the cathode current (I_{CA}=I_{G} +I_{A}) which is the sum of these two currents flows.

In addition, the gate current I_{G} is adjusted by the voltage difference between the gate terminal and the cathode terminal, and the anode current I_{A} is proportional to the gate current as shown in the formula I_{A}=(TR/(1−TR))I_{G} (where I_{A} is the anode current, TR is the transfer rate, and I_{G} is the gate current).

Therefore, the present disclosure can adjust the anode current by adjusting the voltage difference between the gate terminal and the cathode terminal.

The present disclosure can adjust the voltage of the cathode terminal by fixing the gate terminal voltage and adjusting the current of the cathode current source 500.

For example, when the current of the cathode current source 500 is increased, the voltage at the cathode terminal of the electron emission part 100 decreases, thereby increasing the voltage difference between the gate terminal and the cathode terminal.

Due to this, the gate current increases, and the anode current also increases in proportion to the increase rate of the gate current by the formula I_{A}=(TR/(1−TR))I_{G} (where I_{A} is the anode current, TR is the transfer rate, and I_{G} is the gate current).

In addition, the anode current detection operation of the present disclosure is as follows.

In general, since the voltage source has the same supplied current and collected current, the gate current supplied to the gate line 610 connected to the gate positive terminal Vgate+of the gate voltage source 600 is collected as an equal amount of current by the first branch line 621 connected to the gate negative terminal Vgate− of the gate voltage source 600.

In the present disclosure, a cathode current (I_{CA}=I_{G}+I_{A}) flowing in a line 620 connected to a cathode current source 500 is branched into a first branch line 621 connected to a gate negative terminal Vgate− of a gate voltage source 600 among the cathode currents, and the remaining anode current I_{A} among the cathode currents is branched into a second branch line 622 and enters a current detection part 800.

Accordingly, the current detection part 800 detects the input anode current, and the current control part 300 controls the cathode current source 500 that adjusts the cathode current based on the detected anode current, thereby maintaining the anode current constant.

In this way, the present disclosure enables the detection of the anode current in a low voltage range without direct connection to the anode terminal by connecting the current detection part to the cathode current source and the gate voltage source to the branch point of the line connecting between the cathode current source and the current detection part, thereby enabling easy, simple, and inexpensive circuit implementation while precisely controlling the anode current.

In addition, since the present disclosure detects the anode current through a single current detection device, the overall device configuration is simple, and since compensation is performed only for the anode current, the current can be precisely controlled.

In addition, since the present disclosure detects the anode current between the cathode terminal and the ground terminal of the device, it can be configured as a device having a voltage range corresponding to several V to several tens of V, and the stability of the entire device is high, and a high-precision current detection device can be easily implemented while also being able to be implemented at a low cost.

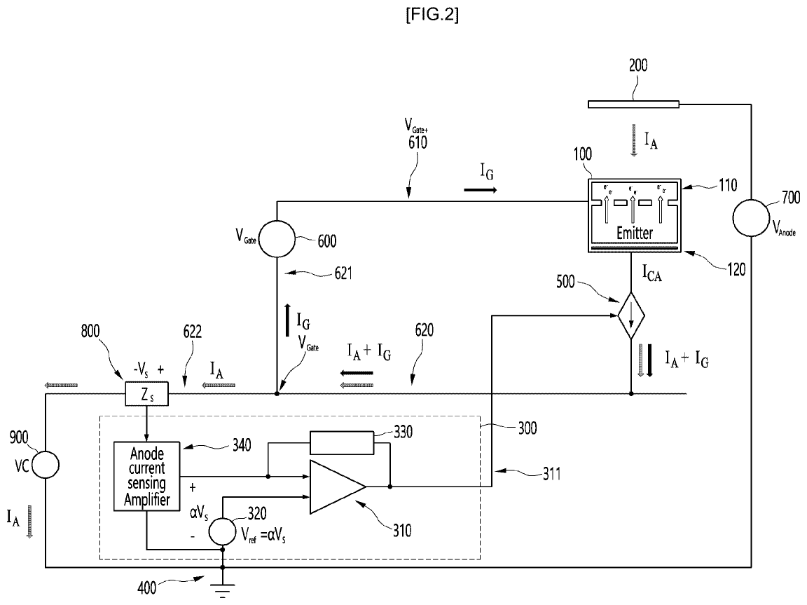

FIG. 2 is a view for explaining a current control part of an X-ray electron emission control device according to an embodiment of the present disclosure, in which the current control part is implemented as an analog device.

As illustrated in FIG. 2, the current control part 300 of the present disclosure can generate a current control signal based on the detected anode current and output it to the cathode current source 500.

The current detection part 800 can receive the anode current from the branch point of the line 620 connecting the cathode current source 500 and the current detection part 800 and output a voltage proportional thereto to the current control part 300.

Here, the voltage output from the current detection part 800 can have a voltage value calculated by a formula consisting of V_{S}=Z_{S}I_{A} (where V_{S} is the output voltage of the current detection part, Z_{S} is the proportional constant of the current detection part, and I_{A} is the anode current).

In addition, the current control part 300 may include an anode current detection amplification part 340 that amplifies the output voltage of the current detection part 800, an error amplification part 310 that compares the output voltage of the anode current detection amplification part 340 with a reference voltage of a reference voltage source and amplifies an error value, and a frequency compensation part 330 that generates a current control signal based on the output voltage of the error amplification part.

Here, the anode current detection amplification part 340 has its input side connected to the current detection part 800, its output side connected to the reference voltage source 320 connected to the ground terminal 400 and the error amplification part 310, respectively, and when the output voltage of the current detection part 800 is input, it can output a voltage proportional to the input based on the ground terminal.

Additionally, the error amplification part 310 may include a first input terminal connected to the anode current detection amplification part 340, a second input terminal connected to the reference voltage source 320, and an output terminal connected to the cathode current source 500.

In addition, the frequency compensation part 330 may have one side connected to a connection line between the first input terminal of the error amplification part 310 and the anode current detection amplification part 340, and the other side connected to a connection line 311 between the output terminal of the error amplification part 310 and the cathode current source 500.

Additionally, the error amplification part 310 and frequency compensation part 330 can generate a current control signal that controls the output voltage of the current detection part 800 to be equal to the reference voltage.

In this way, the configured current control part 300 can generate a current control signal in which the anode current is controlled through a formula consisting of I_{A}=V_{ref}/αZ_{S}, V_{ref}=αV_{S}, V_{S}=Z_{S}I_{A} (where V_{S} is the output voltage of the current detection part, Z_{S} is the proportional constant of the current detection part, I_{A} is the anode current, V_{ref} is the reference voltage, and αV_{S} is the output voltage of the current detection part).

The X-ray electron emission control device of the present disclosure may include an electron emission part 100 that emits electrons, an anode 200 that collects electrons, a gate voltage source 600 connected to a gate 110 of the electron emission part 100, a cathode current source 500 connected to a cathode 120 of the electron emission part 100, a current detection part 800 connected to the cathode current source 500 and detecting anode current, an anode voltage source 700 connected to the anode 200 and a ground part 400, and a voltage source VC 900 connected to the current detection part 800 and the ground part 400.

Here, the voltage source VC 900 can supply a constant voltage to the line 620, 621, 622 connecting the cathode current source 500 and the current detection part 800 via the current detection part 800.

When the anode current inputs, the current detection part 800 can output a voltage proportional to the anode current input (V_{S}=Z_{S}I_{A}, where V_{S} is the output voltage of the current detection part, Z_{S} is the proportional constant of the current detection part, and I_{A} is the anode current).

In addition, the anode current detection amplification part 340 of the current control part 300 can appropriately amplify the output voltage of the current detection part 800, and the error amplification part 310 can compare the output voltage of the anode current detection amplification part with a reference voltage and amplify the error value, which is the difference between the output voltage of the anode current detection amplification part and a reference voltage.

Next, the frequency compensation part 330 can appropriately integrate/differentiate the output voltage together with the error amplification part 310 to create a current control signal.

Next, the current control signal can be used as a signal to control the cathode current source 500 that adjusts the cathode current along the connection line 311.

The anode current detection amplification part 340 receives the voltage across the output terminals of the current detection part 800 and outputs a voltage (αV_{S}) proportional to the input with respect to the ground terminal 400.

In addition, the error amplification part 310 and the frequency compensation part 330 can control the output voltage (αV_{S}) of the anode current detection amplification part 340 to be equal to the reference voltage (V_{ref}) by the cathode current source 500 that adjusts the cathode current.

Accordingly, the current control part 300 of the present disclosure can precisely control the anode current through a formula consisting of I_{A}=V_{ref}/αZ_{S}, V_{ref}=αV_{S}, V_{S}=Z_{S}I_{A} (where V_{S} is the output voltage of the current detection part, Z_{S} is the proportional constant of the current detection part, I_{A} is the anode current, V_{ref} is the reference voltage, and αV_{S} is the output voltage of the current detection part).

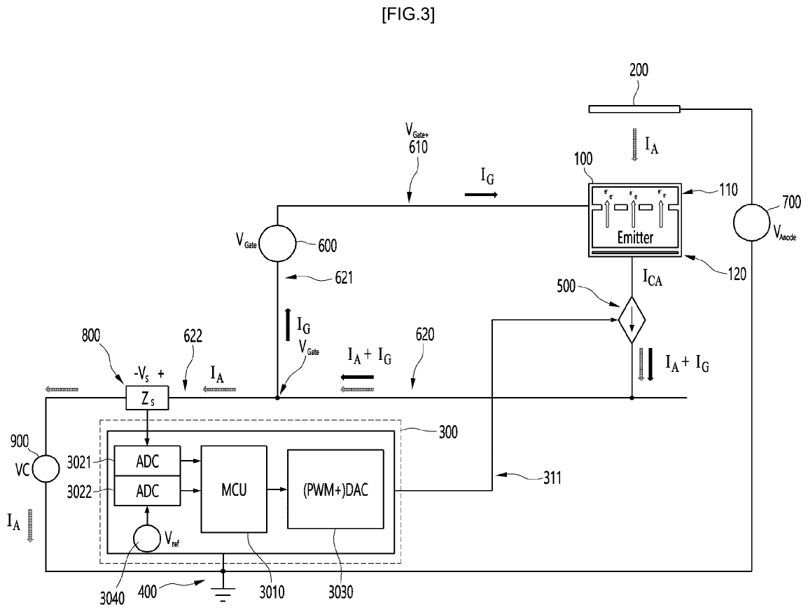

FIG. 3 is a view for explaining a current control part of an X-ray electron emission control device according to another embodiment of the present disclosure, in which the current control part is implemented as a digital device.

As illustrated in FIG. 3, the current control part 3000 of the present disclosure can generate a current control signal based on the detected anode current and output the current control signal to the cathode current source 500.

The current detection part 800 can receive the anode current from the branch point of the line 620 connecting the cathode current source 500 and the current detection part 800 and output a voltage proportional thereto to the current control part 3000.

Here, the voltage output from the current detection part 800 can have a voltage value calculated by a formula consisting of V_{S}=Z_{S}I_{A} (where V_{S} is the output voltage of the current detection part, Z_{S} is the proportional constant of the current detection part, and I_{A} is the anode current).

In addition, the current control part 3000 may include a first analog-to-digital conversion part 3021 that converts the output voltage of the current detection part 800 into a first digital signal, a second analog-to-digital conversion part 3022 that converts the reference voltage of the reference voltage source 3040 into a second digital signal, a control part 3010 that performs computational processing on the first digital signal and the second digital signal, and an output part 3030 that generates and outputs a current control signal based on the processing result performed by the control part 3010.

Here, the current control part 3000 can output the current control signal as an analog signal or as a digital signal including either a Pulse Width Modulation (PWM) signal or a Pulse Frequency Modulation (PFM) signal.

In addition, the control part 3010 can perform computational processing based on a control algorithm including a Proportional Integral Derivative (PID) method, but this is only an example and is not limited thereto.

In this way, the current control part 3000 of the present disclosure configured as such receives the output voltage (V_{S}=Z_{S}I_{A}) of the current detection part 800 and converts it into a digital signal through the first analog-to-digital conversion part 3021, and also converts the reference voltage into a digital signal through the second analog-to-digital conversion part 3022.

Next, the two signals converted into digital signals can perform operations including a control algorithm in the MCU, which is the control part 3010, and output a current control signal that controls the cathode current source 500 through the output part 3030.

At this time, the output signal may be an analog signal that has passed through a DAC (digital to analog converter) or a digital signal.

Here, the digital signal may include a signal capable of controlling the cathode current source 500, such as a Pulse Width Modulation (PWM) signal that outputs with different pulse widths, or a Pulse Frequency Modulation (PFM) signal that outputs with different pulse frequencies.

In addition, as an example of a control algorithm, there is the PID method, but it can also include various other control algorithms.

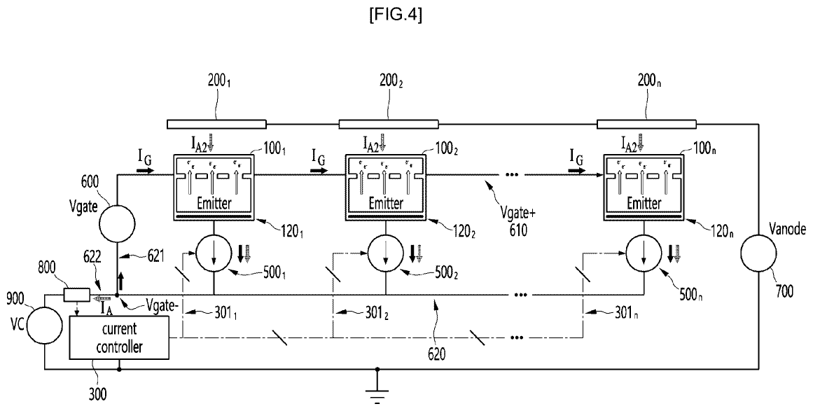

FIG. 4 is a view for explaining an X-ray electron emission control device according to another embodiment of the present disclosure, which implements an X-ray electron emission control device capable of controlling a plurality of electron emission devices.

As illustrated in FIG. 4, the present disclosure may include a plurality of electron emission parts 100₁ to 100ₙ including gates and cathodes, a plurality of anodes 200₁ to 200ₙ respectively arranged to correspond to the plurality of electron emission parts 100₁ to 100ₙ, a plurality of cathode current sources 500₁ to 500ₙ respectively connected to cathodes 120₁ to 120ₙ corresponding to the plurality of electron emission parts 100₁ to 100ₙ, a gate voltage source 600 connected to a gate of any one specific electron emission part among the plurality of electron emission parts 100₁ to 100ₙ, a current detection part 800 connected to the plurality of cathode current sources 500₁ to 500ₙ to detect anode current, and a current control part 300 generating a current control signal based on the detected anode current and outputting the current control signal to the plurality of cathode current sources 500₁ to 500ₙ.

Here, the gate voltage source 600 may have one side connected to the gate of a specific electron emission part 100 and the other side connected to a branch point of a line connecting between a plurality of cathode current sources 500₁ to 500ₙ and the current detection part 800.

In addition, the gates of the plurality of electron emission parts 100₁ to 100ₙ can be connected in series with each other, and the plurality of anodes 200₁ to 200ₙ can be connected in series with each other.

Next, a plurality of cathode current sources 500₁ to 500ₙ can be connected in parallel with each other and connected to a current detection part 800.

Next, the current control part 300 can generate a current control signal including a first control signal for individually turning on/off the cathode current source 500 and a second signal for individually controlling the current value of the cathode current source 500.

Here, the current control part 300 is individually connected to a plurality of cathode current sources 500₁ to 500ₙ through connection lines 301₁ to 301ₙ so as to individually output a current control signal to each cathode current source 500.

In addition, a plurality of cathode current sources 500₁ to 500ₙ can output a cathode current, which is a combination of a gate current and an anode current, to a line 620 connecting a current detection part 800 and a gate voltage source 600.

At this time, the gate voltage source 600 may be connected to a first branch line 621 branched from a branch point of line 620, and the current detection part 800 may be connected to a second branch line 622 branched from a branch point of line 620.

Accordingly, the gate voltage source 600 can receive the gate current branched through the first branch line 621 among the cathode current output from the cathode current source 500, and the current detection part 800 can receive the anode current branched through the second branch line 622 among the cathode current output from the cathode current source 500.

Here, the anode current branched through the second branch line 622 can increase in proportion to its increase rate when the gate current increases, and can decrease in proportion to its decrease rate when the gate current decreases.

For example, the anode current branched through the second branch line 622 may have a current value calculated by a formula consisting of I_{A}=(TR/(1−TR))I_{G} (where I_{A} is the anode current, TR is the transfer rate, and I_{G} is the gate current).

Next, the gate voltage source 600 may include a gate negative terminal connected to the first branch line 621 and a gate positive terminal connected to the gate line of the electron emission part 100.

Here, the gate current amount supplied to the gate 110 of the electron emission part 100 through the gate line connected to the gate positive terminal may be equal to the gate current amount input through the first branch line 621 connected to the gate negative terminal.

At this time, the gate voltage source 600 can increase the gate current in proportion to the increase in the cathode current of the cathode current source 500, and can decrease the gate current in proportion to the decrease in the cathode current of the cathode current source 500.

Next, the cathode current source 500 can adjust the cathode current in response to a current control signal input from the current control part 300 when receiving the current control signal.

Here, the cathode current source 500 can adjust the cathode current in response to the current control signal so that the gate terminal voltage of the electron emission part 100 is fixed and the cathode terminal voltage of the electron emission part 100 is adjusted.

At this time, the cathode current source 500 can increase the cathode current in response to the current control signal to lower the cathode terminal voltage of the electron emission part 100, or can decrease the cathode current in response to the current control signal to increase the cathode terminal voltage of the electron emission part 100.

In addition, the current detection part 800 can receive the anode current from the branch point of the line 620 connecting the cathode current source 500 and the current detection part 800 and output a voltage proportional thereto to the current control part 300.

Here, the voltage output from the current detection part 800 can have a voltage value calculated by a formula consisting of V_{S}=Z_{S}I_{A} (where V_{S} is the output voltage of the current detection part, Z_{S} is the proportional constant of the current detection part, and I_{A} is the anode current).

In addition, the X-ray electron emission control device of the present disclosure may further include a voltage source VC 900 having one side connected to a current detection part 800 and the other side connected to a ground part 400.

Here, the voltage source VC 900 can supply a constant voltage to the line 620, 621, 622 connecting the cathode current source 500 and the current detection part 800 via the current detection part 800.

Next, the current control part 300 can generate a current control signal in which the anode current is controlled through a formula consisting of I_{A}=V_{ref}/αZ_{S}, V_{ref}=αV_{S}, V_{S}=Z_{S}I_{A} (where V_{S} is the output voltage of the current detection part, Z_{S} is the proportional constant of the current detection part, I_{A} is the anode current, V_{ref} is the reference voltage, and αV_{S} is the output voltage of the current detection part).

Additionally, the present disclosure may further include an anode voltage source 700 having one side connected to the anode 200 and the other side connected to the ground part 400.

In this way, when driving a plurality of electron emission devices, if the characteristics of the plurality of electron emission devices are different, the control parameters must be individually set for each electron emission device to suit the corresponding characteristics; however, the present disclosure can control the anode current constantly without the need to individually set the control parameters even if the individual characteristics of the electron emission devices are different.

In addition, the present disclosure can control the anode current to be constant regardless of whether the electron emission device ages or the surrounding environment changes during use of the electron emission device.

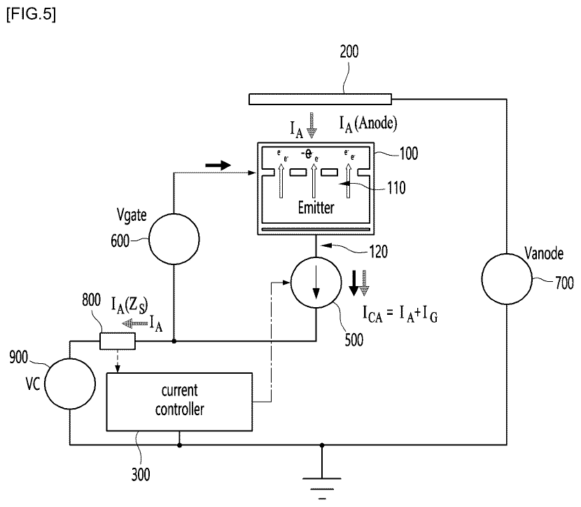

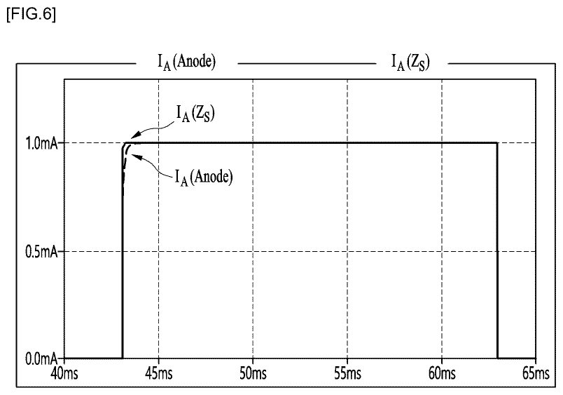

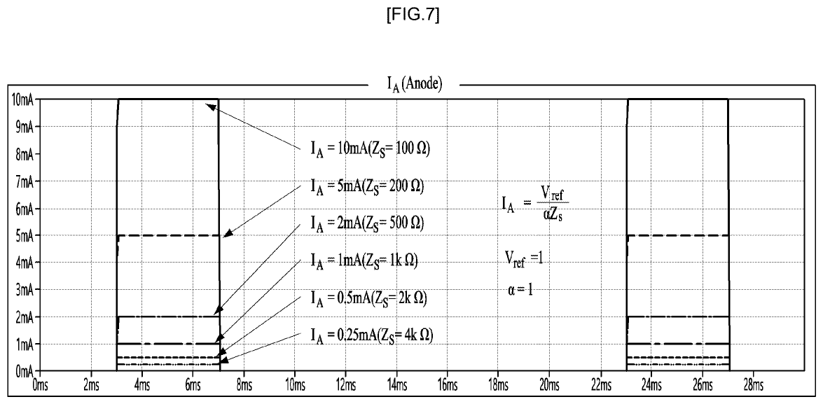

FIG. 5 is a view for explaining an X-ray electron emission control device for simulation according to one embodiment of the present disclosure, and FIGS. 6 and 7 are graphs illustrating the results of simulating the X-ray electron emission control device of FIG. 5.

As illustrated in FIG. 5, the X-ray electron emission control device for simulation may include a cathode current source 500 connected to the cathode of the electron emission part 100, a current detection part 800 connected to the cathode current source 500 to detect an anode current, and a current control part 300 that generates a current control signal based on the detected anode current and outputs the signal to the cathode current source 500.

Here, the gate voltage source 600 may have one side connected to the gate of the electron emission part 100 and the other side connected to a branch point of a line connecting between the cathode current source 500 and the current detection part 800.

In addition, the cathode current source 500 can output the cathode current, which is the combination of the gate current and the anode current, to the branch point of the line connecting between the cathode current source 500 and the current detection part 800.

At this time, the gate voltage source 600 can receive the gate current branched through the first branch line among the cathode current output from the cathode current source 500, and the current detection part 800 can receive the anode current branched through the second branch line among the cathode current output from the cathode current source 500.

In addition, the current detection part 800 can receive the anode current from the branch point of the line connecting between the cathode current source 500 and the current detection part 800 and output a voltage proportional thereto to the current control part 300.

Here, the voltage output from the current detection part 800 can have a voltage value calculated by a formula consisting of V_{S}=Z_{S}I_{A} (where V_{S} is the output voltage of the current detection part, Z_{S} is the proportional constant of the current detection part, and I_{A} is the anode current).

In this way, by simulating the configured X-ray electron emission control device, it is possible to confirm whether the anode current measured at the anode terminal matches the current flowing in the current detection part 800, and whether the anode current is precisely controlled.

FIG. 6 is a simulation result of the device of the present disclosure illustrated in FIG. 5 when the ratio value of TR is 80/100 in TR=I_{A}/I_{CA} (where I_{A} is the anode current, TR is the transmission rate, and I_{CA} is the cathode current) of the electron emission device.

As illustrated in FIG. 6, the graph compares the anode current (I_{A}(Anode)) measured at the anode 200 terminal of FIG. 5 and the current flowing through the current detection part 800 (I_{A}(Z_{S}) (where Z_{S} is the proportional constant of the current detection part, and I_{A} is the anode current), and it can be seen that the two currents are almost identical.

FIG. 7 illustrates the results of simulating the anode current by changing the proportional constant Z_{S} value of the current detection sensor, which is the current detection part 800.

As illustrated in FIG. 7, it can be confirmed that the anode current is precisely controlled according to the proportional constant Z_{S} value of the current detection sensor.

It can be seen that the anode current is precisely controlled by the formula consisting of the proportional constant value of the current detection sensor and I_{A}=V_{ref}/αZ_{S}, V_{ref}=1, α =1 (where Z_{S} is the proportional constant of the current detection part, I_{A} is the anode current, and V_{ref} is the reference voltage).

In this way, the present disclosure enables the detection of the anode current in a low voltage range without direct connection to the anode terminal by connecting the current detection part to the cathode current source and the gate voltage source to the branch point of the line connecting between the cathode current source and the current detection part, thereby enabling easy, simple, and inexpensive circuit implementation while precisely controlling the anode current.

In addition, since the present disclosure detects the anode current through a single current sensing device, the overall device configuration is simple, and since compensation is performed only for the anode current, the current can be precisely controlled.

In addition, since the present disclosure detects the anode current between the cathode terminal and the ground terminal of the device, it can be configured as a device having a voltage range corresponding to several V to several tens of V, and the stability of the entire device is high, and a high-precision current detection device can be easily implemented while also being able to be implemented at a low cost.

### INDUSTRIAL APPLICABILITY

The X-ray electron emission control device according to the present disclosure has remarkable industrial applicability because it is possible to precisely control the anode current while enabling easy, simple, and inexpensive circuit implementation.

What is claimed is:

1 An X-ray electron emission control device comprising:
an electron emission part emitting electrons;
an anode collecting the electrons;
a gate voltage source connected to a gate of the electron emission part;
a cathode current source connected to a cathode of the electron emission part;
a current detection part connected to the cathode current source and detecting an anode current; and,
a current control part generating a current control signal based on the detected anode current and outputting the current control signal to the cathode current source, and
wherein the gate voltage source has a side connected to the gate of the electron emission part and the other side connected to a branch point of a line connecting between the cathode current source and the current detection part.

2 The X-ray electron emission control device of claim 1,
wherein the cathode current source outputs a cathode current, which is a combination of the gate current and the anode current, to a branch point of a line connecting between the cathode current source and the current detection part.

3 The X-ray electron emission control device of claim 2,
wherein the gate voltage source is connected to a first branch line branched from the branch point of the line, and
wherein the current detection part is connected to a second branch line branched from the branch point of the line.

4 The X-ray electron emission control device of claim 3,
wherein the gate voltage source receives the gate current branched through the first branch line among the cathode current output from the cathode current source, and
wherein the current detection part receives the anode current branched through the second branch line among the cathode current output from the cathode current source.

5 The X-ray electron emission control device of claim 4,
wherein the gate voltage source includes a gate negative terminal connected to the first branch line and a gate positive terminal connected to the gate line of the electron emission part, and
wherein the gate current amount supplied to the gate of the electron emission part through the gate line connected to the gate positive terminal is the same as the gate current amount input through the first branch line connected to the gate negative terminal.

6 The X-ray electron emission control device of claim 1,
wherein the current detection part receives the anode current from a branch point of a line connecting between the cathode current source and the current detection part and outputs a voltage proportional thereto to the current control part.

7 The X-ray electron emission control device of claim 6,
wherein the voltage output from the current detection part has a voltage value calculated by a formula consisting of V_{S}=Z_{S}I_{A} (where V_{S} is the output voltage of the current detection part, Z_{S} is the proportional constant of the current detection part, and I_{A} is the anode current).

8 The X-ray electron emission control device of claim 1,
wherein the current control part includes:
an anode current detection amplification part amplifying the output voltage of the current detection part;
an error amplification part amplifying an error value by comparing the output voltage of the anode current detection amplification part with a reference voltage of a reference voltage source; and
a frequency compensation part generating the current control signal based on the output voltage of the error amplification part.

9 The X-ray electron emission control device of claim 8,
wherein the current control part generates a current control signal in which the anode current is controlled by a formula consisting of I_{A}=V_{ref}/αZ_{S}, V_{ref}=αV_{S}, V_{S}=Z_{S}I_{A} (wherein, V_{S} is the output voltage of the current detection part, Z_{S} is the proportional constant of the current detection part, I_{A} is the anode current, V_{ref} is the reference voltage, and αV_{S} is the output voltage of the current detection part).

10 The X-ray electron emission control device of claim 1,
wherein the current control part includes:
a first analog-to-digital conversion part converting the output voltage of the current detection part into a first digital signal;
a second analog-to-digital conversion part converting the reference voltage of the reference voltage source into a second digital signal;
a control part performing computational processing on the first digital signal and the second digital signal; and,
an output part generating and outputting a current control signal based on the processing result computed by the control part.

11 An X-ray electron emission control device comprising:
a plurality of electron emission parts including gates and cathodes;
a plurality of anodes respectively arranged corresponding to the plurality of electron emission parts;
a plurality of cathode current sources respectively connected to the cathodes corresponding to the plurality of electron emission parts;
a gate voltage source connected to a gate of one specific electron emission part among the plurality of electron emission parts;
a current detection part connected to the plurality of cathode current sources to detect an anode current; and,
a current control part generating a current control signal based on the detected anode current and outputting the signal to the plurality of cathode current sources,
wherein the gate voltage source has a side connected to the gate of the specific electron emission part and the other side connected to a branch point of a line connecting between the plurality of cathode current sources and the current detection part.

12 The X-ray electron emission control device of claim 11,
wherein the gates of the plurality of electron-emission parts are connected in series with each other, and
wherein the plurality of anodes are connected in series with each other.

13 The X-ray electron emission control device of claim 11,
wherein the plurality of cathode current sources are connected in parallel with each other and connected to the current detection part.

14 The X-ray electron emission control device of claim 11,
wherein the current control part generates a current control signal including a first control signal for individually turning on/off the cathode current source and a second signal for individually controlling the current value of the cathode current source.

15 The X-ray electron emission control device of claim 11,
wherein the current control part is individually connected to each of the plurality of cathode current sources and individually outputs the current control signal to each cathode current source.
